(19) United States
(12) Patent Application Publication
(10) Pub. No.: US 2026/0132226 A1
(43) Pub. Date: May 14, 2026

(54) DISPERSIBLE AND BIODEGRADABLE MODIFIED STARCH ADDITIVE FOR REINFORCED POLYMERS

(71) Applicant: MITO MATERIAL SOLUTIONS, INC., Indianapolis, IN (US)

(72) Inventors: Kevin KEITH, Indianapolis, IN (US); Bhishma SEDAI, Indianapolis, IN (US); Ishan N. JAYALATH, Indianapolis, IN (US)

(21) Appl. No.: 18/702,102

(22) PCT Filed: Oct. 18, 2022
(86) PCT No.: PCT/US2022/046978

§ 371 Date: Apr. 17, 2024

Related U.S. Application Data
(60) Provisional application No. 63/256,972, filed on Oct. 18, 2021.

(51) Int. Cl. C08B 31/12; B32B 5/02; B32B 5/26; C08L 3/08; C08L 67/03

(52) U.S. Cl. CPC C08B 31/12; B32B 5/02; B32B 5/26; C08L 3/08; C08L 67/03; B32B 2250/20; B32B 2260/021; B32B 2260/046; B32B 2262/106; B32B 2307/546

(57) ABSTRACT

Disclosed herein are additives made by modifying starch with different types of polyhedral oligomeric silsesquioxane (POSS). The starch-POSS additives can provide advantageous properties to polymeric materials.

### CROSS-REFERENCE TO RELATED APPLICATIONS

This application claims the benefit of priority to U.S. Provisional Application No. 63/256,972, filed Oct. 18, 2021, the entire disclosure of which is hereby incorporated by reference.

### FIELD OF THE INVENTION

Some aspects of the invention related generally modified starch compounds for use in polymer formulations.

### BACKGROUND

Starch may be useful as an additive for epoxy resins due to its natural abundance, biodegradability, renewability, and low cost. However, the inherent hydrophilicity and hydrogen bonding of starch molecules cause poor dispersion and weaker interfacial adhesion between hydrophilic starch fillers and hydrophobic polymers/resins such as epoxies. As a result, starch additives tend to aggregate and agglomerate in the polymer matrix such that they disrupt the desired effects of the additives.

### SUMMARY OF THE INVENTION

Aspects of the invention include at least one starch-based additive synthesized by covalently grafting EP 0409 (Glycidyl POSS®, available from Hybrid Plastics) having the structure:

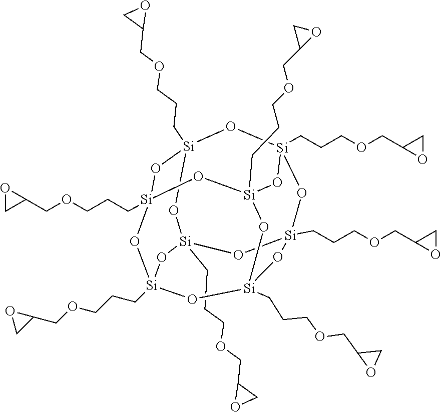 [SMILES: C(COCC1CO1)C[Si]12O[Si]3(CCCOCC4CO4)O[Si]4(CCCOCC5CO5)O[Si](CCCOCC5CO5)(O1)O[Si]1(CCCOCC5CO5)O[Si](CCCOCC5CO5)(O2)O[Si](CCCOCC2CO2)(O3)O[Si](CCCOCC2CO2)(O4)O1]

to high amylose starch using dimethyl aminopyridine (DMAP) and aluminum triflate (Al(OTf)₃) as catalysts. Aspects of the invention includes a one-pot, mild and scalable synthetic method for the production of the compounds disclosed herein.

Aspects of the invention include an economical, efficient, and simplified filtration process (without doing precipitation with water) for use in the production of the compounds disclosed herein.

Aspect of the invention include using coupling agents as necessary for the production of the compounds disclosed herein.

Aspects of the invention include additives for efficient dispersion in epoxy without additional modification with polyvinyl pyrrolidone (PVP). See, for example, patent application publication number WO 2015/143434 A1, wherein the use of PVP is reported to increase the dispersion in resin. Aspects of the invention involve illustrating the effect of starch-POSS on the thermo-mechanical properties of polymeric materials.

Aspects of the invention include various chemical procedures, including using oxidized starch, and various coupling agents.

### BRIEF DESCRIPTION OF THE FIGURES

FIG. 1 illustrates a chemical structure of repeating unit of amylose starch.

FIG. 2A illustrates the chemical structure of EP0409 POSS.

FIG. 2B illustrates the chemical structure of EP0408—epoxy cyclohexyl POSS.

FIG. 2C illustrates the chemical structure of AM 0265 aminopropyl isobutyl POSS.

FIG. 2D illustrates the chemical structure aminopropyl isooctyl POSS.

FIG. 3A illustrates the chemical structure of ethylenediamine.

FIG. 3B illustrates the chemical structure of dimethyl carbonate.

FIG. 4A illustrates the chemical structure of shows the chemical structure of a bisphenol A diglycidyl ether.

FIG. 4B illustrates the chemical structure of EPON 828 epoxy resin part A.

FIG. 4C illustrates the chemical structure of octylamine or fatty acid amine.

FIG. 5 illustrates the chemical reaction of starch with EP0409 POSS

FIG. 6A shows the FTIR spectra of starch-POSS.

FIG. 6B shows the TGA thermographs of starch-POSS.

FIG. 6C shows the NMR spectra of starch-POSS.

FIG. 6D shows XRD patterns of starch-POSS.

FIG. 6E shows the contact angle measurements of starch-POSS.

FIG. 7 Left Panel, shows the change of tan delta as a function of temperature; the Middle Panel shows the loss modulus as a function of temperature; and the Right Panel shows the storage modulus as a function of temperature.

FIG. 8A shows flexural strength test results of starch-POSS in carbon fiber reinforced EPON 828 composites.

FIG. 8B shows flexural modulus (MPa) test results of starch-POSS in carbon fiber reinforced EPON 828 composites.

FIG. 9A shows FTIR spectra of corn starch, POSS and starch-POSS.

FIG. 9B shows thermogravimetry (TGA) of corn starch, POSS and starch-POSS.

FIG. 10A shows ¹H NMR of corn starch, POSS and starch-POSS.

FIG. 10B shows XRF of starch-POSS.

FIG. 10C shows XRD of starch and starch-POSS.

FIG. 11 shows a TGA of starch-POSS at different time intervals.

FIG. 12A shows FTIR spectra of starch-POSS at different time intervals.

FIG. 12B shows FTIR spectra of starch-POSS at different time intervals.

FIG. 12C shows FTIR spectra of starch, POSS and starch-POSS.

FIG. 13 shows initial flex test results of Epon 828 and Epicure 3370 and starch-POSS.

FIG. 14 shows initial flex test results of Epon 862 and Epicure 3370 and starch-POSS.

FIG. 15A shows an FTIR spectrum of POSS-starch.

FIG. 15B shows TGA thermogram of POSS-starch.

### DETAILED DESCRIPTION

While the technology has been illustrated and described in detail in the figures and description, the same is to be considered as illustrative and not restrictive in character, it being understood that only certain embodiments have been shown and described and that all changes and modifications that come within the spirit of the novel technology are desired to be protected. As well, while the technology was illustrated using specific examples, theoretical arguments, accounts, and illustrations, these illustrations and the accompanying discussion should by no means be interpreted as limiting the technology.

In certain embodiments, additives are made by modifying starch with different types of polyhedral oligomeric silsesquioxane (POSS). In certain embodiments, the additives mitigate dispersion problems or improve the thermal and mechanical performance of polymeric materials (e.g., epoxy resins), or both. In certain embodiments, the grafted POSS molecules in starch-POSS have improved thermal stability compared to starch. In certain embodiments, starch-POSS has improved dispersibility in polymeric material (e.g., both thermoplastic and thermoset) than starch alone. In certain embodiments, starch-POSS is less hygroscopic compared to starch. In certain embodiments, starch-POSS has more-epoxide and —OH functional groups than starch to interact with polymer matrices. Those reactive sites (functional groups) in the starch-POSS can form covalent bonds as well as hydrogen bonds or other types of interactions like van der Waals interaction with the polymer matrices. In certain embodiments, a detergent is not required if the composition contains a starch-POSS.

In certain embodiments, a starch-based additive comprises a starch and a POSS coupled to the starch. In certain embodiments, the starch-POSS can be characterized by an IR spectra comprising characteristic IR peaks for starch (e.g., glucose ring stretching, —OH groups) and for the POSS (e.g., Si—O—Si bonds). In certain preferred embodiments where the linking group comprises an oxirane, the characteristic IR peaks can also include peaks for the oxirane. For example, characteristic IR peaks for starch-POSS can include peaks at about 1088 cm⁻¹, about 1162 cm⁻¹, about 1201 cm⁻¹, about 3300 cm⁻¹, and combinations thereof, and preferably includes characteristic peaks at about 1088 cm⁻¹ and about 1201 cm⁻¹.

In certain embodiments, a starch-POSS additive analyzed by elemental analysis shows the inclusion of carbon, oxygen, and silicon. In certain embodiments, the starch-POSS additive is composed of about 35% to about 45% carbon by mass, about 1% to about 5% silicon by mass, and about 50% to about 65% oxygen by mass. In certain embodiments, the starch-POSS additive is composed of about 43% carbon by mass, about 3% silicon by mass, and about 53% oxygen by mass.

In certain embodiments, a starch-POSS additive analyzed by XRD has characteristic patterning when compared to starch only. For example, reacting POSS with starch can disrupt the crystallinity of starch such that the low intensity peaks at about (2θ) of 15°, 17°, and 22° becomes a broad peak in the range of 13°-24° in the starch-POSS additive.

In certain embodiments, a starch-POSS additive analyzed by TGA has characteristic peaks. For example, a starch-POSS additive can show a mass loss up to 600° C. from the degradation of starch and the organic vertex groups of POSS. In certain embodiments, the mass fraction of silica estimated from TGA is about 5% to about 9% and is preferably about 7%.

In certain embodiments, the starch-POSS additive comprises about 1% to about 25% by weight POSS. For example, the starch-POSS additive can comprise about 3% to about 25%, about 5% to about 25%, about 10% to about 25%, about 15% to about 25%, about 3% to about 20%, about 3% to about 15%, about 3% to about 12%, about 5% to about 12% or about 5% to about 10% by weight POSS and preferably comprises about 5% to about 10% by weight POSS or about 15% to about 25% by weight POSS. Illustratively, not all of the linking groups on the POSS have reacted with the starch. For example, if the unreacted POSS had eight epoxy groups, only one, two, three, of four of these groups react with the starch to form the starch-POSS additive. In certain embodiments, the POSS comprises fewer than eight epoxy groups. In certain embodiments, the remaining apex groups can be can be any alkyl or aryl group, for example methyl, butyl, isobutyl, propyl, ethyl, or phenyl, and which are usually non-functionalized (e.g., lack a functional group).

In certain embodiments, the starch comprises at least 30% by weight amylose and optionally less than about 70% by weight amylopectin. In certain embodiments, the starch contains at least about 40%, at least about 50%, at least about 60%, at least about 65%, at least about 70%, at least about 75%, at least about 80%, or at least about 85% by weight amylose, and preferably comprises about 65% to about 80% by weight amylose. In certain embodiments, the POSS contains about 65% to about 95%, about 65% to about 90%, about 65% to about 85%, or about 70% to about 80% amylose. In certain embodiments, the starch comprises less than about 60%, less than about 50%, or less than about 40% amylopectin.

In certain embodiments, the POSS comprises a linking group configured to couple to the starch, for example to a hydroxyl on a carbohydrate of the starch. The number of linking groups per POSS can vary and the POSS can comprise one, two, three, four, five, six, seven, or eight linking groups and preferably comprises two, three, four, five, six, seven, or eight linking groups. In certain preferred embodiments, the POSS has a linking group extending from each apex of the POSS structure. For example, in preferred embodiments, the POSS is a T8 POSS and comprises eight linking groups, for example epoxide groups.

In certain embodiments, the linking group is an amine, an acrylate (e.g., methacrylate), a silanol, an epoxy, or an ester, and is preferably an epoxy group. For example, the POSS can be a T8 POSS having one to eight, and preferably two to eight linking groups such as an amine, an acrylate (e.g., methacrylate), a silanol, and is preferably an epoxy group. When coupled to the starch, the epoxy group forms an ether linkage. In certain preferred embodiments, the POSS is a T8 POSS and includes an epoxy group at each apex for a total of 8 epoxy groups per structure. In certain preferred embodiments, the POSS is EP 0409.

In certain embodiments, the grafted POSS molecules in starch-POSS have improved thermal stability compared to starch. In certain embodiments, starch-POSS has improved dispersibility in polymeric material (e.g., both thermoplastic and thermoset) than starch alone. In certain embodiments, starch-POSS is less hygroscopic compared to starch. In certain embodiments, starch-POSS has more-epoxide and —OH functional groups to interact with polymer matrices. Those reactive sites (functional groups) in the starch-POSS can form covalent bonds as well as hydrogen bonds or other types of interactions like van der Waals interaction with the polymer matrices.

In certain embodiments, a starch-based additive was prepared by covalently grafting EP 0409 to high amylose starch using dimethyl aminopyridine (DMAP) and aluminum triflate (Al(OTf)₃) as catalysts. The term starch-POSS will be used herein to describe the linking of POSS to starch (e.g., grafting). Further, the large-scale synthesis procedure, characterization, and effect of starch-POSS on mechanical properties of epoxy resins are presented herein.

Aspects of the invention include a one-pot, mild and scalable synthesis method for the production of the compounds disclosed herein.

Aspects of the invention include an economical, efficient, and simplified filtration process (e.g., without doing precipitation with water) for use in the production of the compounds disclosed herein.

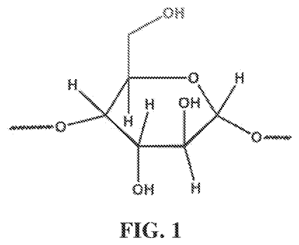

Referring now to FIG. 1, the chemical structure of the repeating unit of starch. A high amylose (up to 70%) starch may be used for grafting to EP 0409 POSS.

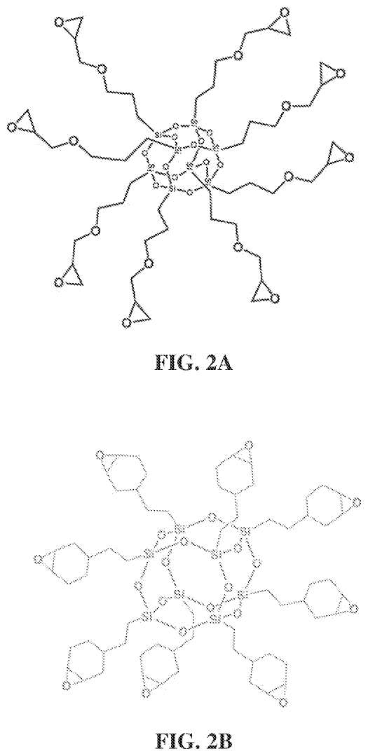

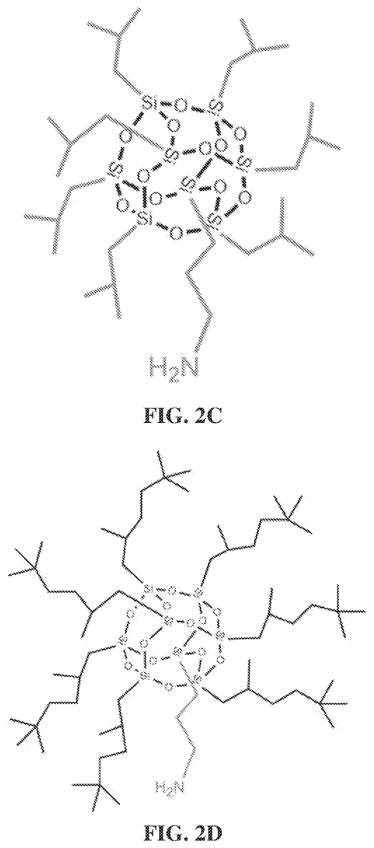

Referring now to FIGS. 2A, 2B, 2C, and 2D. Chemical structure of EP 0409 POSS and alternative forms of POSS molecules for various reactions.

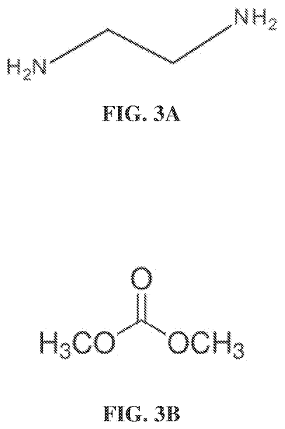

Referring now to FIG. 3, chemical structures of exemplary coupling agents for the reaction are shown in FIG. 3. The use of a specific coupling agent can be determined depending on the structure of the POSS molecule that might react with starch.

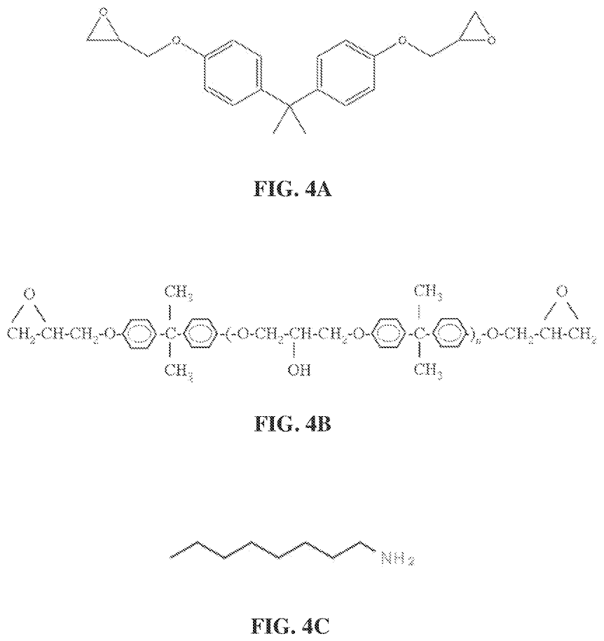

Referring now to FIGS. 4A, 4B, and 4C, chemical structures of molecules that can be used as alternatives to POSS.

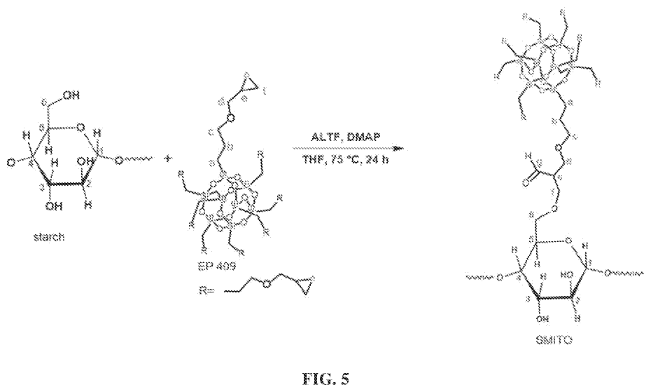

Referring now to FIG. 5, a reaction scheme for starch and EP 0409 is shown. One illustrative method for the filtration and drying of starch-POSS is described herein.

In certain embodiments, the POSS is combined with a starch in the presence of a catalyst. The catalyst can be a mixture of a Lewis acid and a base. Exemplary catalysts include Lewis acid catalysts such as those based on metals such as aluminum, boron, silicon, tin, titanium, zirconium, iron, copper, zinc, and preferably is aluminum triflate Al(OTf)₃. Exemplary bases include hydroxybenzotriazole (HOBt), organolithium (BuLi and MeLi) and pyridine bases such as dimethylaminopyridine (DMAP), and is preferably DMAP. For example, if the POSS includes an oxirane linking group, a catalyst combination of Al(OTf)₃ and DMAP can be effective for ring opening of the epoxide with alcohols (e.g., from the starch) and amines (e.g., from ethylene diamine). In certain embodiments, the POSS is combined with a starch in the presence of N,N′-dicylohexylcarbodiimide (DCC).

In certain embodiments, the POSS is combined with a starch is the presence of a solvent. In certain embodiments, the solvent is THF or dimethyl carbonate, and is preferably THF.

In certain embodiments, the reaction between POSS and starch is heated. In certain embodiments, the reaction is heated at least to about 55° C. or at least to about 60° C. In certain embodiments, the reaction is heated to a range of about 55° C. to about 85° C. or to a range of about 65° C. to about 85° C. In certain embodiments, the reaction is heated to about 65° C.

In certain embodiments, the starch is first heated to desiccate the starch. In certain embodiments, the starch is heated at about 75° C. to about 85° C. for at least 12 hours and preferably about 18 hours.

In certain embodiments, the starch is added to the reactor before adding the POSS or the catalyst. In certain embodiments, the starch is added to the reactor and dispersed in a solvent, preferably THF. In certain embodiments, the starch/THF dispersion is heated, preferably to about 50° C. to about 75° C.

In certain embodiments, the POSS and starch are reacted for at least about 12 hours. In certain embodiments, the POSS and starch are reacted for at least about 16 hours, for at least about 17 hours, or for at least about 20 hours. In certain embodiments, the POSS and starch react for about 12 hours to about 24 hours, about 16 hours to about 24 hours, or about 20 hours to about 24 hours. In certain preferred embodiments, the POSS and starch are reacted for about 20 hours to about 22 hours.

In certain preferred embodiments, after the starch and POSS react for the desired amount of time, the reaction mixture is cooled, preferably to room temperature. In certain embodiments, the starch-POSS settles. The supernatant can then be decanted and the resulting solid washed again with a solvent such as THF or IPA. In certain embodiments, the washed starch-POSS can be further dried.

In certain embodiments, the starch-POSS additive is combined with a polymeric material and dispersed therein. In certain embodiments, the polymeric material is selected from bisphenol A (BPA), bisphenol F (BPF), polyethylene terephthalate (PET), PE (Polyethylene), PP (polypropylene), polyurethanes, vinyl esters and polyesters. In certain embodiments, the polymeric material is a thermoplastic (e.g., polyethylene, polypropylene, polycarbonate, nylon, polyethylene terephthalate (PET), polyvinyl chloride, polystyrene, silicone, and preferably is PET). In certain embodiments, the polymeric material is a thermoset (e.g., epoxy, phenolformaldehyde resin, polyurethane, melamine, polyoxybenzylmethylenglycolanhydride, polyester resin, vinylester resin, polyimides) or a combination thereof.

In certain embodiments, the starch-POSS additive is added at a particular concentration to the polymeric material. For example, the starch-POSS additive can be present at about 0.01% to about 25 wt % of the composite. In certain embodiments, starch-POSS can be present at about 0.1% to about 20%, about 0.1% to about 15%, about 0.1% to about 10%, about 0.1% to about 5%, about 0.1% to about 3%, about 0.1% to about 2%, about 0.1% to about 1%, about 0.1% to about 0.5%, or about 0.1% to about 0.3% by weight of the composite. In certain embodiments, starch-POSS can be present at about 0.1%, about 0.25%, about 0.5%, about 1%, about 3%, about 5%, about 10%, about 15%, about 20%, or about 25% by weight of the composite.

In certain embodiments, starch-POSS can replace non-renewable fillers like mica. In certain embodiments, starch-POSS can increase the bonding and adherence of polymer matrices. In certain embodiments, starch-POSS can make plastics lighter, stronger and more durable. In certain embodiments, starch-POSS can prevent cracking, or improve tensile, flex and compression properties when added to recycled plastics.

Starch-POSS may enhance toughness, modulus, strength and damping properties of polymers. It may be employed to enhance mechanical properties of materials that are made from thermoplastics and thermosets polymers. Examples of applications include: product packing, automotive, aerospace, toys, telecommunication equipment, computers, sports equipment, household appliances, construction materials, office equipment and supplies, medical equipment and supplies.

In certain embodiments, a carbon fiber composite comprises a plurality of layers of carbon fiber, and starch-POSS and an epoxy interspersed between carbon fiber layers. In certain embodiments, a carbon fiber composite comprises a fiber reinforced with a starch-POSS infused epoxy is used. The starch-POSS is incorporated into the epoxy between 0.01% to 25% wt of the resin before the catalyst is introduced. In certain embodiments, the epoxy comprises 4,4′-isopropylidenediphenol or a 4,4′-isopropylidenedipenol-epichlorohydrin copolymer. The starch-POSS can be incorporated by a shear force such as shear mixing, milling, and sonication. The composite is cured according the standard technical data sheet that the formulator provides.

In certain embodiments, a composite that includes starch-POSS can demonstrate superior flexural modulus, as measured by ASTM D790, when compared to a material that lacks the starch-POSS. In certain embodiments, the starch-POSS composite has a flexural modulus that is at least about 5%, at least about 10%, at least about 15%, at least about 20% or at least about 25% higher than material that lacks the starch-POSS (e.g., a starch-POSS/PET/epoxy material shows improvement compared to a PET/epoxy material).

In certain embodiments, a composite that includes starch-POSS can demonstrate superior max flex stress, as measured by ASTM D790, when compared to a material that lacks the starch-POSS. In certain embodiments, the starch-POSS composite has a max flex stress that is at least about 3%, at least about 5%, at least about 10%, or at least about 13% higher than material that lacks the starch-POSS (e.g., a starch-POSS/PET/epoxy material shows improvement compared to a PET/epoxy material).

In certain embodiments, a composite that includes starch-POSS can demonstrate superior max force, as measured by ASTM D790, when compared to a material that lacks the starch-POSS. In certain embodiments, the starch-POSS composite has a max force that is at least about 3%, at least about 5%, at least about 10%, or at least about 13% higher than material that lacks the starch-POSS (e.g., a starch-POSS/PET/epoxy material shows improvement compared to a PET/epoxy material).

In certain embodiments, a composite that includes starch-POSS can demonstrate superior flex strain at yield, as measured by ASTM D790, when compared to a material that lacks the starch-POSS. In certain embodiments, the starch-POSS composite has a max flex stress that is at least about 3%, at least about 5%, at least about 10%, or at least about 13% lower than material that lacks the starch-POSS (e.g., a starch-POSS/PET/epoxy material shows improvement compared to a PET/epoxy material).

While the disclosed subject matter is amenable to various modifications and alternative forms, specific embodiments are described herein in detail. The intention, however, is not to limit the disclosure to the particular embodiments described. The disclosure is intended to cover all modifications, equivalents, and alternatives falling within the scope of the disclosure as defined herein and reasonable inference based on the disclosure and teaches thereof.

Similarly, although illustrative methods may be described herein, the description of the methods should not be interpreted as implying any requirement of, or particular order among or between, the various steps disclosed herein. However, certain embodiments may require certain steps and/or certain orders between certain steps, as may be explicitly described herein and/or as may be understood from the nature of the steps themselves (e.g., the performance of some steps may depend on the outcome of a previous step).

### Definitions

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

Following long-standing patent law convention, the terms “a”, “an”, and “the” refer to “one or more” when used in this application, including the claims. Thus, for example, reference to “a fiber” includes a plurality of such fibers, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “graft,” “grafting,” or “grafted,” when referring to a starch-POSS molecule is meant to describe the coupling of a POSS to the starch, for example, by covalent bond formation.

### EXAMPLES

### Example 1

Corn starch (70% amylose, 150 g) was dispersed in 3 L of tetrahydrofuran (THF) in a 5 L reaction vessel for 15 min with moderate stirring at 60° C. Then DMAP (15 g) was dissolved in 300 mL of THF and added to the starch dispersion and further stirred for 10 min. EP409 (150 g) and Al(OTf)₃ (8 g) were dissolved in 500 mL of THF and added to the starch solution over 15 min. The reaction was carried out for 24 h before proceeding to the product recovery process.

After the reaction, starch-POSS was allowed to settle at the bottom of the reaction vessel once stirring is stopped. The THF phase was decanted and then the wet starch-POSS cake was filtered to remove the remaining THF in the product. Then, the product was washed two times with 2 L each of THF and 1 L acetone with filtering after each wash. The product was allowed to dry in a fume hood for 1 h and then transferred into a glass bottle. Then, the product was dried in a vacuum oven at room temperature for 2 days before chemical characterization.

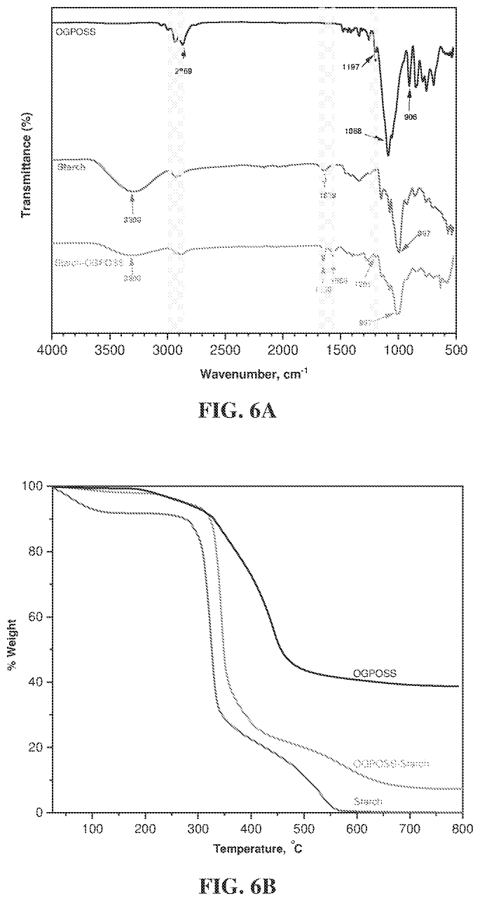

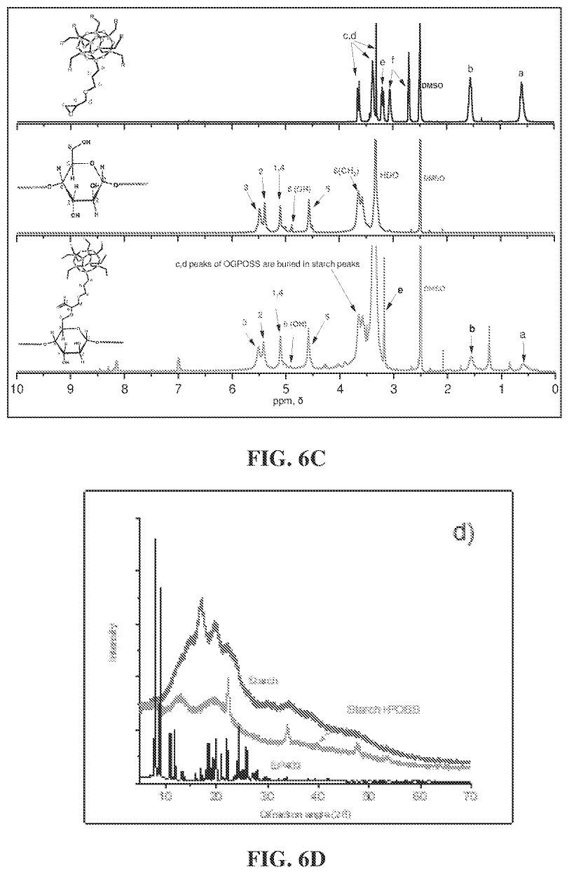

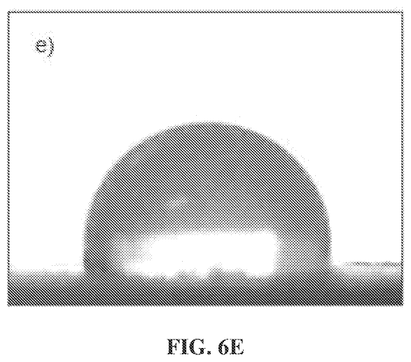

Characterization of the starch-POSS. Referring now to FIGS. 6A, 6B, 6C, 6D, and 6E. The following techniques were used to characterize starch-POSS: thermogravimetric analysis (TGA); Fourier transform infrared spectroscopy (FTIR); NMR spectroscopy; and X-ray diffraction (XRD).

### Example 2

The starch-POSS additive from Example 1 was combined with each of Hexion EPON 828 (4,4′-isopropylidenedipenol-epichlorohydrin copolymer) available from Hexion, Inc.) and Entropy Red (4,4′-isopropylidenediphenol, oligomeric reaction products with 1-chloro-2,3-epoxypropane, oxirane, ethyl alcohol, benzyl alcohol; available from Gougeon Brothers, Inc. 100 Patterson Ave. Bay City, MI 48706, U.S.A.) and using a 3-roll mill and diluted to make the desired concentration of the additive in the polymeric material.

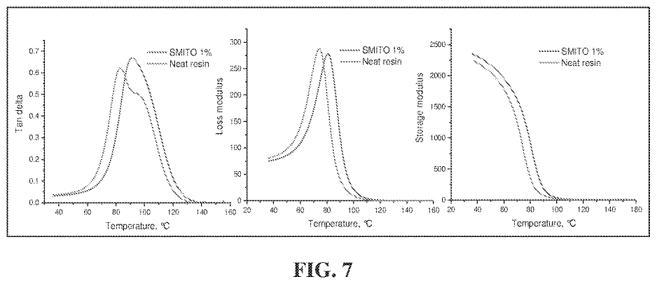

The effect of the starch-POSS additive on the thermo-mechanical properties of Entropy Red resin was evaluated with dynamic mechanical analysis. The tan delta, storage modulus, and loss modulus of Entropy Red resin with and without starch-POSS are shown (FIG. 7). The starch-POSS additive increased the tan delta and storage modulus in the samples with the Entropy Red resin.

### Example 3

Carbon fiber reinforced composite (CFRC) panels were fabricated using vacuum-assisted hand layup. For the preparation of fiber reinforced composites, starch-POSS product and Epon 828 epoxy resin part A dispersion was prepared. For making 0.5% starch-POSS dispersion, 2 grams of starch-POSS was mixed with 398 grams of Epon 828 part A and mixed with a wooden spatula. Then, the mixture was milled with a three-roll mill for 5 cycles at 300 rpm speed. Starch-POSS/Epon 828 dispersion was used in between the lay-up of carbon fiber fabric. During the lay-ups, Starch-POSS/Epon 828 dispersion measured, Epicure 3370 was added (100:38 ratio) and resin/hardener weight was equal to the carbon fiber weight. After completion of the lay-up, a caul plate was placed on the top, covered with a vacuum bag and it was sealed well with tacky tape. Finally, excess resin was removed using vacuum. The composite was cured at room temperature for 24 hours and post cured at 100° C. for 2 hours.

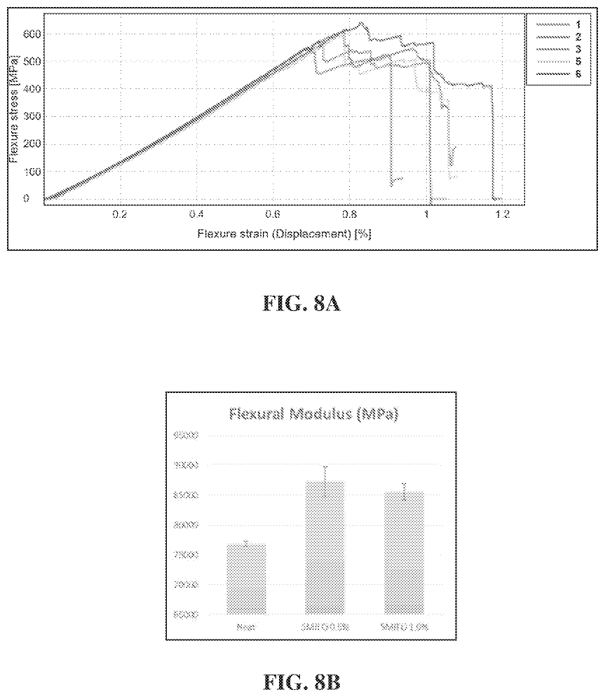

The 4-point bending flexural test was conducted according to ASTM D70 standards (FIG. 8). The starch-POSS additive increased the flexural modulus of the CFRC composites in EPON 828 resin by approximately 14%.

### Example 4

Starch-POSS was integrated into polyethylene terephthalate (PET) polymer by following standard plastic compounding process. At first, master batches of the PET and Starch-POSS were prepared. The masterbatch was used to make PET/starch-POSS composite pellets of 0.1%, 0.25% and 0.5% final concentration. Neat PET and PET/starch-POSS composite pellets were used to prepare samples for flexural characterization. Samples for the flexural properties test were prepared using a standard thermoplastic injection molding. The flex test samples had different concentrations of starch-POSS 0.1%, 0.25% and 0.5%. The flex tests were performed following ASTM D790 method. The test results showed the flex toughness increased by 9% with the addition of 0.5% of starch-POSS in the PET matrix. The addition of 0.5% of starch-POSS in the PET polymer increased its flex modulus by about 10%.

### Example 5

Corn starch (70% amylose, 2 g) in 30 ml of tetrahydrofuran (THF) was dispersed in a 100 mL round bottom flask for 15 min with moderate stirring at 75° C. Then 4-dimethylaminopyridine (DMAP) (500 mg) was dissolved in 10 ml of THF and added to the starch dispersion and further stirred for 10 min. A portion of POSS (2 g) and Al(OTf)₃ (150 mg) was dissolved in 20 ml of THF and added dropwise to the starch solution over 15 min. The reaction was carried out for 24 hours before recovering the product. The reaction mixture was allowed to cool to room temperature, filtered, and Soxhlet extracted with 100 ml of THF and washed with two portions of 25 ml acetone. Finally, the product was dried in a vacuum oven at 65° C. for 24 h before chemical characterization.
Solvent: Tetrahydrofuran (THF)
Catalyst: 4-dimethylaminopyridine (DMAP) and Al-triflate Al(OTf)₃
Temperature: 75° C.

### Example 6

Corn starch (70% amylose, 200 g) and 3 L of tetrahydrofuran (THF) were dispersed in a 5 L round bottom flask for 15 min with moderate stirring at 50° C. Then DMAP was dissolved in 250 ml of THF and added to the starch dispersion and further stirred for 10 min. A portion of POSS (200 g), DMAP (28 g) and aluminum triflate, Al(OTf)₃, (9 g) was dissolved in 20 mL of THF and added dropwise to the starch solution over 15 min. The reaction was carried out for 24 hours before recovery of the product. The reaction mixture was allowed to cool to room temperature, filtered, and washed with 1 L of THF and washed with two portions of 250 ml acetone. Finally, the product was dried in a vacuum oven at 65° C. for 24 h before chemical characterization.

### Characterization of POSS-Starch Hybrid Material

The chemical characterization of starch-POSS was carried out using NMR, FTIR, thermogravimetry (TGA) and X-ray fluorescence (XRF) analysis.

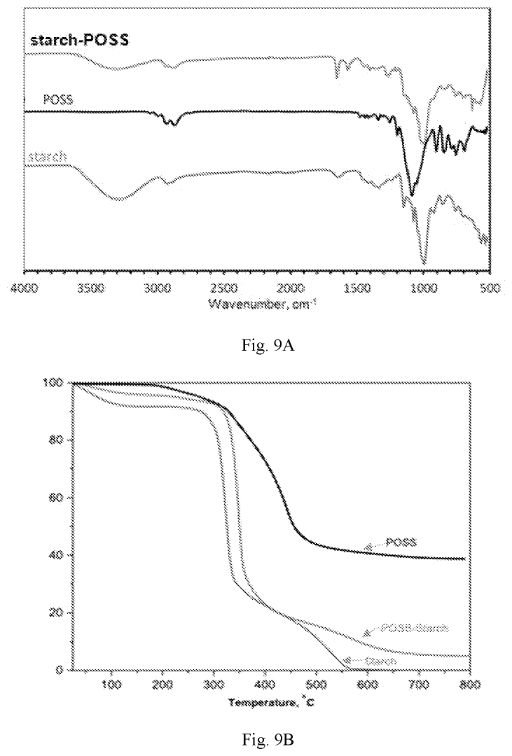

The TGA thermograms and FTIR spectra are shown in FIGS. 9A and 9B, respectively. In FIGS. 9A and 9B, the FTIR spectra were shifted vertically, and the intensities of the spectra were scaled for a clear view of each spectrum. The grafting of POSS to starch was further confirmed by TGA analysis (FIG. 9B). Approximately 60% mass loss of POSS up to 500° C. corresponds to the thermal decomposition of organic groups. The remaining 40% of the residue is from the silicon-oxygen cage. Based on TGA residue (˜5%), the % grafting of the POSS to the starch was approximately 15%.

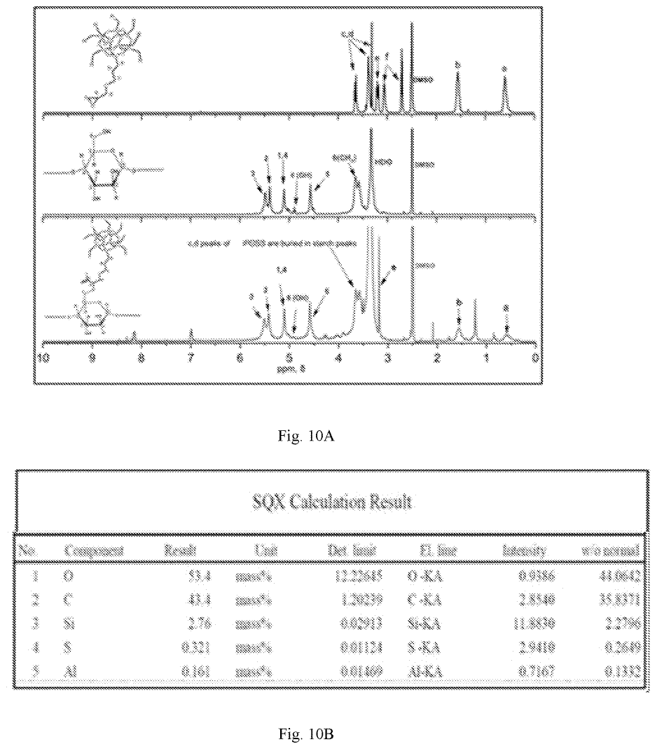

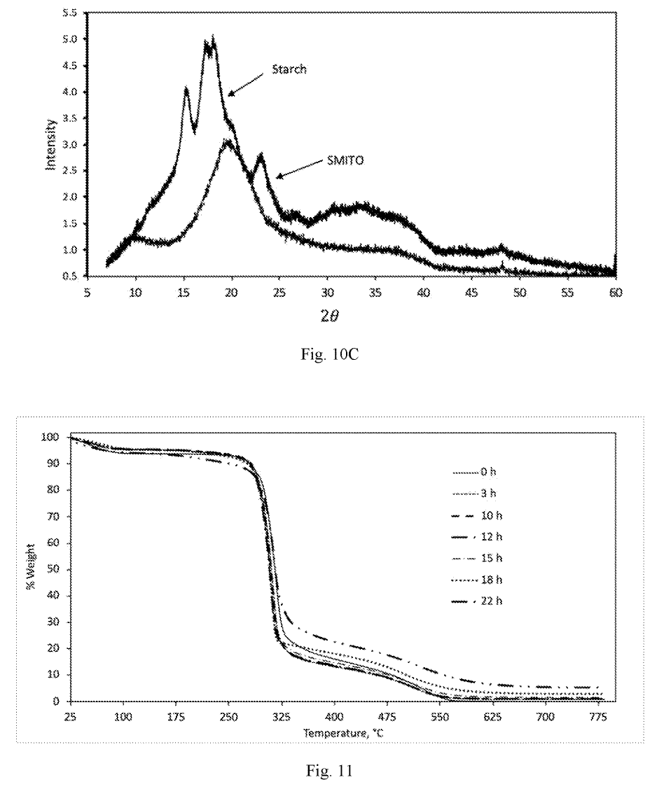

The proton NMR (¹H NMR) spectra were taken and shown in FIG. 10A. The ¹H NMR of starch and POSS are shown for the comparison. The characteristic X-rays were collected with a Tube-above wavelength dispersive X-ray fluorescence spectrometer, Rigaku ZSX Primus IV with measurement range from Boron (B) to Uranium (U) for quantitative determination of major and minor elements present in the sample. Coins type XRF sample pellets of 20 mm in diameter and 2 mm in thickness were prepared using a hydraulic press. The resulting pellets scanned on both sides of surfaces.

The XRF results provided the chemical composition (elemental analysis) of starch-POSS and is shown in FIG. 10B. Using XRF, the presence of silicon was confirmed after the grafting reaction.

The TGA of starch, EP0409 POSS, and starch-POSS are shown in FIG. 9B. In the EP0409 POSS thermogram, approximately 62% of the mass loss up to 600° C. corresponds to the thermal decomposition of the organic vertex groups, while 38% of the white residue was from the oxidized silicon. According to the molecular formula of the glycidyl POSS (C₆H₁₁O₂)₈ (SiO_{1.5}), (Mw 1337.88 g/mol), the mass fraction of silica in EP0409 POSS based on SiO_{1.5} is equal to 31.6%. However, it is likely silica is in the form of SiO₂ after reacting with oxygen in the air during the TGA. Assuming SiO₂ is formed instead of SiO_{1.5}, the mass fraction of silica in EP0409 POSS should be equal to 36%, close to the value of the TGA residue.

In starch-POSS, the mass loss up to 600° C. resulted from the complete degradation of starch and the organic vertex groups of EP0409 POSS. The mass fraction of silica was estimated from TGA to be ˜7%, if the final residue is SiO₂. Therefore, the mass percentage of EP0409 POSS grafted on starch in the composite was estimated to be ˜20%.

The effect of the grafting reaction on the microstructure of starch was performed using XRD analysis (FIG. 10D). The XRD patterns of corn starch show three low-intensity peaks at different diffraction angles (2θ) of 15°, 17°, and 22°. In the starch-POSS composite, the initial crystallinity of the starch is disrupted and appears as one broad peak. The three peaks of starch merged to make one broad peak in the range of 13°-24°.

### Example 6

Approximately 1.7 kg (70% amylose, 3.75 lbs) of corn starch (Ingredion) was measured and heated at 80° C. for 18 hours. It was kept inside a desiccator before the starting the reaction. A 100 L steel reactor was connected with a condenser unit and water circulating hose was connected, temperature was set to 2° C. A heating oil bath hose was connected to the reactor. 3.3 lbs of starch was measured and dispersed in 10 lbs of THF. The mixture was transferred into the steel reactor. The heating temperature was set at 65° C. Heating was continued for 30 minutes. 282.5 g of 4-Dimethylaminopyridine (DMAP) was measured and dissolved in 6 lbs of THF and added to a starch dispersion after 30 minutes. 3.3 lbs of EP0409 POSS was measured and dissolved in 14.7 lbs (7.5 L) of THF; 45 g of Al-triflate was measured and dissolved in 5 lbs (2.5 L) of THF; both solutions were mixed for 15 minutes. EP0409 POSS and Al-triflate mixture was added into the starch and DMAP mixture after 30 minutes. The liquid level in reactor was 17.3 L. The reaction mixture aliquots were withdrawn at different time intervals (Table 1). The aliquots were filtered and washed with THE two times. The residues were collected, dried and analyzed with a TGA (FIG. 9).

TABLE 1

| Aliquot Number | Time (hours) | TGA residue weight % |
|---|---|---|
| 1 | 0 | |
| 2 | 3 | |
| 3 | 10 | |
| 4 | 12 | 1.2 |
| 5 | 15 | 1.9 |
| 6 | 18 | 3.0 |
| 7 | 33 | 6.5 |

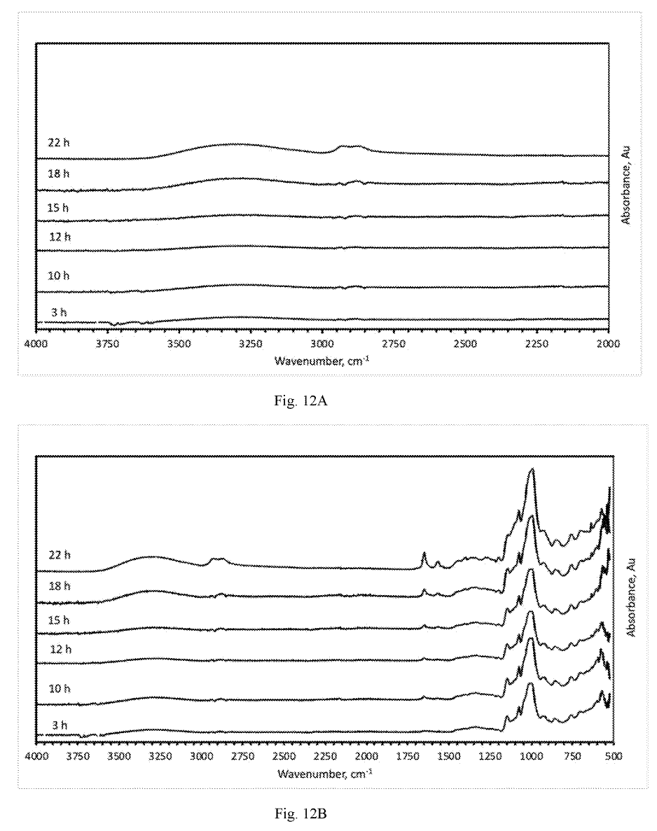

Based on the TGA data (FIG. 11), the reaction was stopped after 22 hours. Before the withdrawal of the reaction mixture, an exhaust fan was started. Reaction mixture was drained in to a plastic bucket and immediately covered in a warm condition.

### Washing and Drying:

After 10 minutes, clear supernatant was observed and white product settled at the bottom; the clear liquid was discarded. All the top parts of the reactor removed and the remaining product was scrapped with spatula. The product was collected in a bucket. The final product mixture was allowed to settle for 10 minutes and the clear supernatant was discarded. The residue was dispersed in 10 lbs of THF and mixed to 15 minutes with a shear mixture (500 rpm). It was allowed to settle and supernatant was discarded. The white residue was again dispersed in 10 lbs of IPA and mixed for 15 minutes with a shear mixture (500 rpm). It was allowed to settle and supernatant was discarded. The white residue was again dispersed in 10 lbs of acetone and mixed for 15 minutes with a shear mixture (500 rpm). It was allowed to settle and the supernatant was discarded. The white colored final product was taken in bucket; weighed and it was found to be ˜4.7 lbs in wet condition. It was kept inside fume-hood in open condition left to dry. The product was reweighed and the weight was found to be 3.8 lbs; it was still wet; the big chunks were broken and left for drying; a small amount of product sent for TGA analysis. The product weight was taken, was found to be 3.5 lbs after 84 hrs. The weight of the product remained constant after 84 hrs.

### Characterization of Scaled Batch

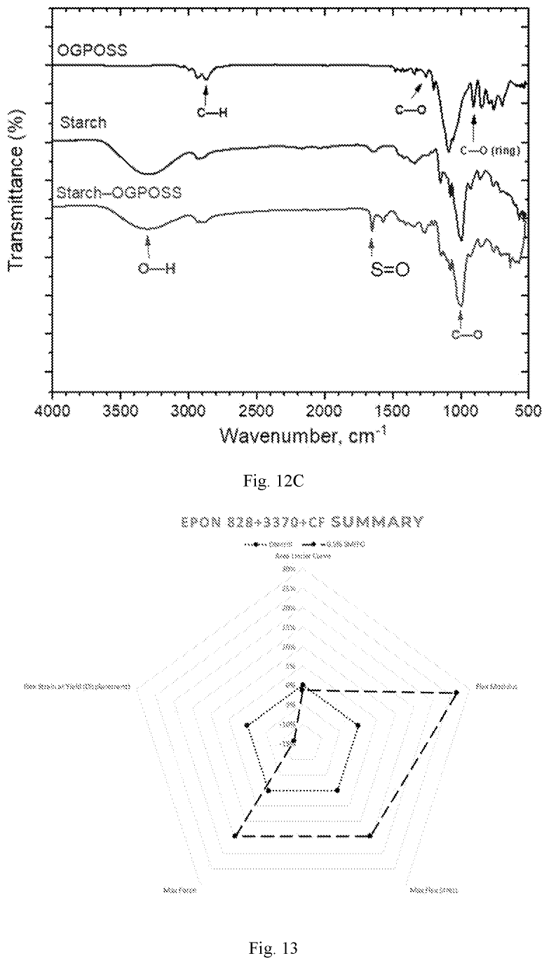

FTIR spectra of the starch-POSS from different time intervals and the final product were taken. The FTIR spectra are shown in FIGS. 12A and 12B. The peaks intensities for —CH₂ stretching (2869 to 2931 cm⁻¹) and Si—O—Si (1088 cm⁻¹) have increased in the final product. Further characterization of dried product was done with FTIR and TGA.

In the POSS spectrum, the IR peaks at 1088 and 2869 cm⁻¹ can be assigned as Si—O—Si of POSS cage and C-Hin the organic vertex groups. The IR absorption bands of oxirane ring were found at 1197, 906, and 788 cm⁻¹ can be assigned as ring breathing, asymmetric ring deformation, and symmetric ring deformation, respectively. The characteristic IR absorption bands of raw starch can be found at 995, 2931, and 3300 cm⁻¹. The IR peaks can be assigned as follows. The IR absorption band at 997 cm⁻¹ is a characteristic of the glucose ring (C—O—C) in the structure of starch. The IR peaks appearing at 2931 and 3300 cm⁻¹ are due to C—H stretching, and O—H stretching vibration in starch. The IR peak at 1639 cm⁻¹ is for the residual water that exists even after extensive drying before FTIR analysis. The assignment of the POSS, starch, and starch-POSS FTIR spectrum is tabulated in Table 2.

TABLE 2
Peaks from FTIR spectra

| | | Wavenumber, |
|---|---|---|
| Sample | Type of bond | cm⁻¹ |
| POSS | Oxirane ring | 788, 906, 1197 |
| | Si—O—Si | 1088 |
| | C—H | 2869 |
| Starch | C—O—C | 997 |
| | H₂O | 1639 |
| | C—H | 2931 |
| | O—H | 3300 |
| Starch-POSS | O—H | 3300 |
| | S═O | 1680 |
| | Si—O—Si | 1088 |
| | Si—O—Si | 1162 |
| | Oxirane ring | 1201 |

The starch-POSS spectrum (FIG. 12C), shows evidence of successful incorporation of POSS on starch. A change between raw starch and the starch-POSS material is the characteristic peak of the oxirane ring, which appeared at 1197 cm⁻¹ in POSS, is shifted by 4 cm⁻¹ and appeared at 1201 cm⁻¹. The evidence of the presence of silica in the hybrid material is the Si—O absorption band which was at 1088 cm⁻¹ in POSS. In the starch-POSS spectrum, the characteristic glucose band has appeared as extra broadening compared to the raw starch. The extra broadening of the glucose peak of starch is due to the merging of the Si—O absorption band of POSS with the starch glucose band. To further confirm the presence of silica in the hybrid material, the FTIR spectrum of white residue that remained after the TGA analysis of the starch-POSS hybrid material was recognized as the silica from the POSS cage. The presence of a trace amount of aluminum triflate catalyst gives a peak at 1680 cm⁻¹ that can be assigned to the S—O. This was confirmed by the FTIR spectrum recorded that had an intense peak around 1162 cm⁻¹ from the Si—O—Si stretching vibrations of the silicon cage.

### Example 7

Integration of Starch-POSS into Thermoplastic Materials

Starch-POSS was integrated into polyethylene terephthalate (PET) polymer by following standard plastic compounding process. At first, master batches of the PET and Starch-POSS were prepared. The masterbatch was used to make PET/Starch-POSS composite pellets of 0.1%, 0.25% and 0.5% final concentration. Neat PET and PET/Starch-POSS composite pellets were used to prepare samples for flexural characterization.

### Mechanical Properties

For the preparation of fiber reinforced composites, starch-POSS and Epon 828 epoxy resin part A dispersion was prepared. For making 0.5% starch-POSS dispersion, 2 grams of starch-POSS was mixed with 398 grams of Epon 828 part A and mixed with a wooden spatula. Then the mixture was milled with a three-roll mill for 5 cycles at 300 rpm speed. Starch-POSS/Epon 828 dispersion was used in between the lay-up of carbon fiber fabric. During the lay-ups, starch-POSS/Epon 828 dispersion measured, Epicure 3370 was added (100:38 ratio) and resin/hardener weight was equal to the carbon fiber weight. After completion of the lay-up, a caul plate was placed on the top, covered with a vacuum bag and it was sealed well with tacky tape. Finally, excess resin was squeezed out using vacuum. The composite was cured at room temperature for 24 hours and post cured at 100° C. for 2 hours.

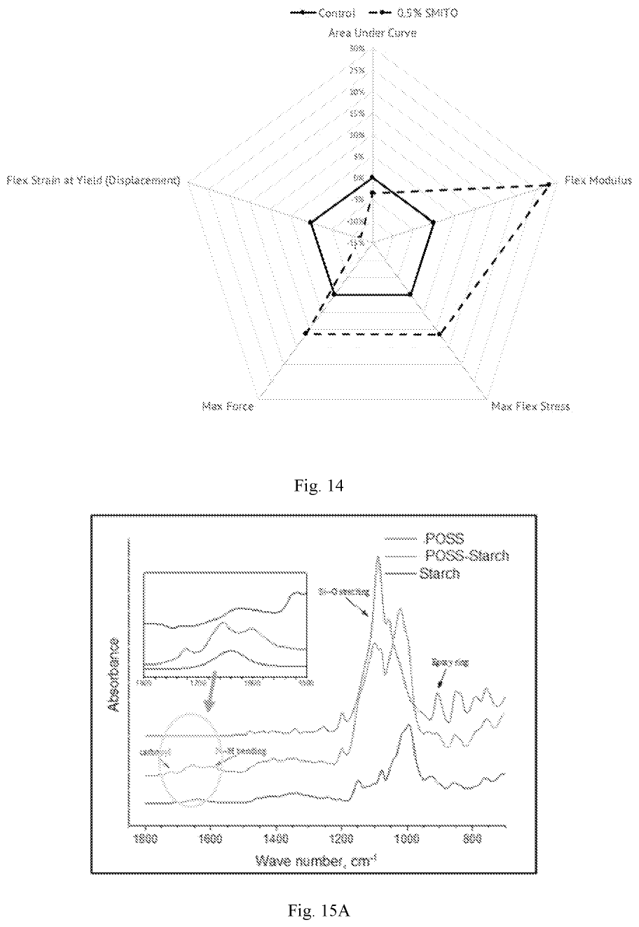

Epon 862/Epicure 3370 and starch-POSS samples were prepared following the same procedure and standard technical data sheet of resin manufacturer. Composite samples were cut and samples were tested with a 4-point flex fixture using an Instron Universal Testing Machine (3400 series). The summarized test results of Epon 828/Epicure 3370 and Epon 862/Epicure 3370 epoxy resins with starch-POSS are shown in FIGS. 13 and 14. The dashed lines in both FIGS. 13 and 14 show the performance of starch-POSS at 0.5% concentration in part A of resins.

### PET/Starch-POSS Flexural Properties Test (Flex Test) Results

Samples for the flexural properties test were prepared using a standard thermoplastic injection molding in a customer facility. The flex test samples had different concentrations of starch-POSS 0.1%, 0.25%, and 0.5% as shown Table 3. The flex tests were performed following ASTM D790 method. The test results showed the flex toughness increased with the addition of 0.5% of starch-POSS in the PET matrix, as shown in Table 3. The addition of 0.5% of starch-POSS in the PET polymer increased its flex modulus, as shown in Table 3.

TABLE 3

| % starch-POSS | Area Under the | | Flex Mod | |
|---|---|---|---|---|
| in PET | Curve (MPa) | % increase | (MPa) | % increase |
| 0 | 13.66 | — | 2362.77 | — |
| 0.1 | 13.84 | 1.3 | 2390.94 | 1.2 |
| 0.25 | 14.56 | 6.2 | 2518.8 | 6.2 |
| 0.5 | 14.87 | 8.1 | 2597.86 | 9.0 |

### Example 8

High amylose corn starch (70% amylose) was gelatinized in deionized (DI) water at 85° C. for 1 hour. Then the temperature was reduced to 55° C. and oxidation reaction was carried out using hydrogen peroxide 35% (w/w) solution and Cu²⁺ catalyst. The oxidation reaction carried out for 2 h under mild stirring and then diethylene diamine functionalized POSS was added to the mixture in the presence of 1-(3-dimethylaminopropyl)-3-ethylcarboimide hydrochloride (EDC) and dimethyl aminopyridine (DMAP). Then POSS-starch was precipitated using isopropyl alcohol and washed two times each with tetrahydrofuran and acetone. The product was dried in a vacuum under room temperature before characterization by Fourier transform infrared (FTIR) spectroscopy and thermogravimetric analysis (TGA).
Solvent: Water and Tetrahydrofuran
Catalyst: 1-(3-dimethylaminopropyl)-3-ethylcarboimide hydrochloride (EDC) and dimethyl aminopyridine (DMAP)
Temperature: 55° C.

### Characterization of POSS-Starch Hybrid Material

The product was characterized with Fourier transform infrared spectroscopy (FTIR) and thermogravimetric analysis (TGA).

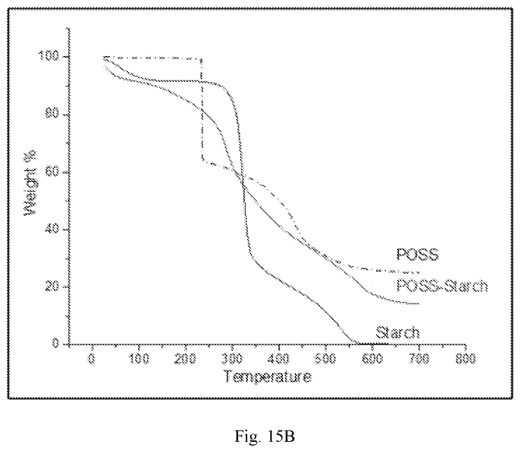

The FTIR spectra of POSS, starch, and POSS-starch hybrid material shown in FIG. 15A. The FTIR spectra were shifted vertically, and the intensities of the spectra were scaled for a clear view of each spectrum. The FTIR spectrum of POSS-starch (POSS-starch spectrum in FIG. 15A) appears to be a combination of raw spectra of POSS and starch. Chemical grafting of EDA functionalized POSS onto starch was confirmed by the appearance of amide peak at 1735 cm⁻¹. The shoulder at 905 cm⁻¹ can be assigned as the unopened epoxy rings in the POSS.

The grafting of POSS to starch was further confirmed by TGA analysis (FIG. 15B). Approximately 60% mass loss of POSS up to 500° C. corresponds to the thermal decomposition of organic vertex groups. The remaining 40% of the residue is from the silicon-oxygen cage. Based on TGA residue (˜15%), the % grafting of the POSS to the starch was approximately 53%.

1. A starch-POSS additive comprising:
a starch that is at least 30% by weight amylose, and
a POSS coupled to the starch.

2. The starch-POSS additive of claim 1, wherein the POSS is covalently linked to the starch through an amide, an ether, a silanol, an acrylate, or an ester.

3. The starch-POSS additive of claim 1 or 2, wherein the POSS comprises an epoxy group.

4. The starch-POSS additive of any one of claims 1-3, wherein the POSS of the starch-POSS comprises fewer than eight epoxy groups.

5. The starch-POSS of any one of claims 1-4, wherein the POSS is a T8 POSS.

6. The starch-POSS additive of any one of claims 1-5, wherein the starch is at least 50% by weight amylose.

7. The starch-POSS additive of any one of claims 1-5, wherein the starch is at least 70% by weight amylose.

8. The starch-POSS additive of any one of claims 1-7, wherein the starch-POSS has characteristic IR peaks at about 1088 cm⁻¹ and about 1201 cm⁻¹.

9. The starch-POSS additive of any one of claims 1-7, wherein the starch-POSS has at least two characteristic IR peaks selected from about 1088 cm⁻¹, about 1162 cm⁻¹, about 1201 cm⁻¹, and about 3300 cm⁻¹.

10. The starch-POSS additive of any one of claims 1-7, wherein the starch-POSS has at least three characteristic IR peaks selected from about 1088 cm⁻¹, about 1162 cm⁻¹, about 1201 cm⁻¹, and about 3300 cm⁻¹.

11. The starch-POSS additive of any one of claims 1-7, wherein the starch-POSS has characteristic IR peaks selected at about 1088 cm⁻¹, about 1162 cm⁻¹, about 1201 cm⁻¹, and about 3300 cm⁻¹.

12. The starch-POSS additive of any one of claims 1-11, wherein the POSS is present at about 1% to about 25% by weight.

13. The starch-POSS additive of any one of claims 1-11, wherein the POSS is present at about 3% to about 20% by weight.

14. The starch-POSS additive of any one of claims 1-13, wherein the starch-POSS, when analyzed by elemental analysis, is composed of about 35% to about 45% carbon by mass, about 1% to about 5% silicon by mass, and about 50% to about 65% oxygen by mass.

15. The starch-POSS additive of any one of claims 1-13, wherein the starch-POSS, when analyzed by elemental analysis, is composed of about 43% carbon by mass, about 3% silicon by mass, and about 53% oxygen by mass

16. A composite comprising
a polymeric material and,
starch-POSS according to any one of claims 1-15 dispersed in the polymeric material.

17. The composite of claim 16, wherein the polymeric material is selected from bisphenol A (BPA), bisphenol F (BPF), polyethylene terephthalate (PET), polyethylene (PE), polypropylene (PP), polyurethane, vinyl ester and polyesters.

18. The composite of claim 16, wherein the polymeric material is a thermoplastic.

19. The composite of claim 18, wherein the thermoplastic is selected from polyethylene, polypropylene, polycarbonate, nylon, polyethylene terephthalate (PET), polyvinyl chloride, polystyrene, and silicone, and preferably is PET.

20. The composite of claim 16, wherein the polymeric material is a thermoset.

21. The composite of claim 20, wherein the thermoset is selected from epoxy, phenolformaldehyde resin, polyurethane, melamine, polyoxybenzylmethylenglycolanhydride, polyester resin, vinylester resin, polyimides.

22. The composite of any one of claims 16-21, wherein the starch-POSS additive is present at about 0.01% to about 25 wt % of the composite.

23. The composite of any one of claims 16-21, wherein the starch-POSS additive is present about 0.1% to about 1% of the composite.

24. The composite of any one of claims 16-23, wherein the composite has a flex mod improvement of at least 5% higher as measured by ASTM D790 as compared to the polymeric material without the starch-POSS additive present.

25. A carbon fiber composite, comprising
a plurality of layers of carbon fiber, and
starch-POSS according to any one of claims 1-15 and an epoxy interspersed between carbon fiber layers.

26. The carbon fiber composite of claim 25, wherein the carbon fiber composite has a flex mod improvement of at least about 10% higher compared to a carbon fiber composite without the starch-POSS present as measured by ASTM D790.

27. The carbon fiber composite of claim 25, wherein the carbon fiber composite has a flex mod improvement of at least 15% higher compared to a carbon fiber composite without the starch-POSS present as measured by ASTM D790.

28. The carbon fiber composite of claim 25, wherein the carbon fiber composite has a flex mod improvement of at least 25% higher compared to a carbon fiber composite without the starch-POSS present as measured by ASTM D790.

29. The carbon fiber composite of any one of claims 25-28, wherein the carbon fiber composite has a max flex stress improvement of at least about 3% higher compared to a carbon fiber composite without the starch-POSS present as measured by ASTM D790.

30. The carbon fiber composite of any one of claims 25-28, wherein the carbon fiber composite has a max flex stress improvement of at least about 10% compared to a carbon fiber composite without the starch-POSS present as measured by ASTM D790.

31. The carbon fiber composite of any one of claims 25-28, wherein the carbon fiber composite has a max flex stress improvement of at least about 13% higher compared to a carbon fiber composite without the starch-POSS present as measured by ASTM D790.

32. The carbon fiber composite of any one of claims 25-31, wherein the carbon fiber composite has a max force improvement of at least about 3% higher compared to a carbon fiber composite without the starch-POSS present as measured by ASTM D790.

33. The carbon fiber composite of any one of claims 25-31, wherein the carbon fiber composite has a max force improvement of at least about 10% higher compared to a carbon fiber composite without the starch-POSS present as measured by ASTM D790.

34. The carbon fiber composite of any one of claims 25-31, wherein the carbon fiber composite has a max force improvement of at least about 13% compared to a carbon fiber composite without the starch-POSS present as measured by ASTM D790.

35. The carbon fiber composite of any one of claims 25-34, wherein the carbon fiber composite has a flex strain at yield improvement that is at least about 3% lower compared to a carbon fiber composite without the starch-POSS present as measured by ASTM D790.

36. The carbon fiber composite of any one of claims 25-34, wherein the carbon fiber composite has a flex strain at yield improvement that is at least about 5% lower compared to a carbon fiber composite without the starch-POSS present as measured by ASTM D790.

37. The carbon fiber composite of any one of claims 25-34, wherein the carbon fiber composite has a flex strain at yield improvement that is at least about 10% lower compared to a carbon fiber composite without the starch-POSS present as measured by ASTM D790.

38. A method of making a starch-POSS material, the method comprising
combining a starch and a POSS comprising at least a linking group in the presence of a catalyst and a solvent to form a starch-POSS material, and
isolating the starch-POSS material,
wherein the starch is at least 30% by weight amylose.

39. The method of claim 38, wherein the linking group is selected from an amine, an acrylate (e.g., methacrylate), a silanol, an epoxy, and an ester, and is preferably an epoxy.

40. The method of claim 38 or 39, wherein the catalyst comprises a Lewis acid.

41. The method of claim 40, wherein the Lewis acid comprises aluminum, boron, silicon, tin, titanium, zirconium, iron, copper, or zinc.

42. The method of claim 40, wherein the Lewis acid is aluminum triflate.

43. The method of any one of claims 38-42, wherein the catalyst comprises a base.

44. The method of claim 43, wherein the base is hydroxybenzotriazole (HOBt), organolithium (BuLi and MeLi) or a pyridine base, such as dimethylaminopyridine (DMAP).

45. The method of claim 44, wherein the base is DMAP.

46. The method of any one of claims 38-45, wherein the solvent comprises THF.

47. The method of any one of claims 38-46, wherein the step of combining is performed at a temperature greater than about 55° C.

48. The method of any one of claims 38-46, wherein the step of combining is performed for at least 16 hours.

49. The method of any one of claims 38-48, wherein the POSS comprises two to eight linking groups.

50. The method of any one of claims 38-48, wherein the POSS comprises eight linking groups.
